(19) United States
(12) Patent Application Publication
(10) Pub. No.: US 2026/0006224 A1
(43) Pub. Date: Jan. 1, 2026

(54) ADAPTIVE INTRA SECONDARY TRANSFORM SET SELECTION AND SIGNALING

(71) Applicant: Tencent America LLC, Palo Alto, CA (US)

(72) Inventors: Tianqi LIU, Palo Alto, CA (US); Madhu PERINGASSERY KRISHNAN, Palo Alto, CA (US); Liang ZHAO, Palo Alto, CA (US); Shan LIU, Palo Alto, CA (US); Han GAO, Palo Alto, CA (US)

(21) Appl. No.: 19/205,943

(22) Filed: May 12, 2025

Related U.S. Application Data
(60) Provisional application No. 63/666,619, filed on Jul. 1, 2024.

(51) Int. Cl. H04N 19/176; H04N 19/159; H04N 19/625; H04N 19/70; H04N 19/91

(52) U.S. Cl. CPC H04N 19/176; H04N 19/159; H04N 19/625; H04N 19/70; H04N 19/91

(57) ABSTRACT

The various implementations described herein include methods and systems for coding video. In one aspect, a method includes receiving a video bitstream comprising a plurality of blocks that includes a current block. The method also includes determining an intra prediction mode for the current block and selecting a secondary transform set from a plurality of secondary transform sets based on coded information comprising the intra prediction mode of the current block. The method further includes reconstructing the current block by applying a secondary transform from the selected secondary transform set.

### RELATED APPLICATIONS

This application claims priority to U.S. Provisional Patent Application No. 63/666,619, entitled “Adaptive Intra Secondary Transform Set Selection and Signaling” filed Jul. 1, 2024, which is hereby incorporated by reference in its entirety.

### TECHNICAL FIELD

The disclosed embodiments relate generally to video coding, including but not limited to systems and methods for selecting transform kernels.

### BACKGROUND

Digital video is supported by a variety of electronic devices, such as digital televisions, laptop or desktop computers, tablet computers, digital cameras, digital recording devices, digital media players, video gaming consoles, smart phones, video teleconferencing devices, video streaming devices, etc. The electronic devices transmit and receive or otherwise communicate digital video data across a communication network, and/or store the digital video data on a storage device. Due to a limited bandwidth capacity of the communication network and limited memory resources of the storage device, video coding may be used to compress the video data according to one or more video coding standards before it is communicated or stored. The video coding can be performed by hardware and/or software on an electronic/client device or a server providing a cloud service.

Video coding generally utilizes prediction methods (e.g., inter-prediction, intra-prediction, or the like) that take advantage of redundancy inherent in the video data. Video coding aims to compress video data into a form that uses a lower bit rate, while avoiding or minimizing degradations to video quality. Multiple video codec standards have been developed. For example, High-Efficiency Video Coding (HEVC/H.265) is a video compression standard designed as part of the MPEG-H project. ITU-T and ISO/IEC published the HEVC/H.265 standard in 2013 (version 1), 2014 (version 2), 2015 (version 3), and 2016 (version 4). Versatile Video Coding (VVC/H.266) is a video compression standard intended as a successor to HEVC. ITU-T and ISO/IEC published the VVC/H.266 standard in 2020 (version 1) and 2022 (version 2). AOMedia Video 1 (AV1) is an open video coding format designed as an alternative to HEVC. On Jan. 8, 2019, a validated version 1.0.0 with Errata 1 of the specification was released.

### SUMMARY

The present disclosure describes amongst other things, systems and methods of video (image) compression, more specifically related to selection of transform sets (e.g., secondary transform sets). The selection of a subset of secondary transform sets from all available secondary transform sets may be based on coded information (e.g., that is available to both the encoding component and the decoding component), such as an intra prediction mode of a current block. By adaptively selecting the subset of transform sets based on coded information, a more accurate and/or efficient transform kernel that improves the quality of the coding (e.g., more accurate encoding/decoding) may be selected, even from a reduced set of second transform sets. In this way, signaling overhead for the transform sets may be reduced. For example, the residual block to which the secondary transform set is applied may have directionality and/or distributions associated with the coded information. Limiting the transform sets to a subset of all available transform sets can reduce encoding time and/or signaling overhead by using fewer bits to signal a set index associated with the selected subset of transform sets.

In accordance with some embodiments, a method of video decoding includes (i) receiving a video bitstream (e.g., a coded video sequence) comprising a plurality of blocks that includes a current block; (ii) determining an intra prediction mode for the current block; (iii) selecting a secondary transform set from a plurality of secondary transform sets based on coded information comprising the intra prediction mode of the current block; and (iv) reconstructing the current block by applying a secondary transform from the selected secondary transform set.

In accordance with some embodiments, a method of video encoding includes (i) receiving video data (e.g., a source video sequence) comprising a plurality of blocks that includes a current block; (ii) determining an intra prediction mode for the current block; (iii) selecting a secondary transform set from a plurality of secondary transform sets based on the intra prediction mode of the current block; and (iv) encoding the current block by applying a secondary transform from the selected secondary transform set.

In accordance with some embodiments, a method of bitstream conversion includes (i) obtaining a source video sequence that comprises a plurality of frames; and (ii) performing a conversion between the source video sequence and a video bitstream of visual media data according to a format rule. The video bitstream comprises a plurality of encoded blocks including a current block. The format rule specifies that: (a) an intra prediction mode is to be determined for the current block; a secondary transform set is to be selected from a plurality of secondary transform sets based on the intra prediction mode of the current block; and (b) the current block is to be reconstructed by applying a secondary transform from the selected secondary transform set.

In accordance with some embodiments, a computing system is provided, such as a streaming system, a server system, a personal computer system, or other electronic device. The computing system includes control circuitry and memory storing one or more sets of instructions. The one or more sets of instructions including instructions for performing any of the methods described herein. In some embodiments, the computing system includes an encoder component and a decoder component (e.g., a transcoder). In accordance with some embodiments, a non-transitory computer-readable storage medium is provided. The non-transitory computer-readable storage medium stores one or more sets of instructions for execution by a computing system. The one or more sets of instructions including instructions for performing any of the methods described herein.

Thus, devices and systems are disclosed with methods for encoding and decoding video. Such methods, devices, and systems may complement or replace conventional methods, devices, and systems for video encoding/decoding. The features and advantages described in the specification are not necessarily all-inclusive and, in particular, some additional features and advantages will be apparent to one of ordinary skill in the art in view of the drawings, specification, and claims provided in this disclosure. Moreover, it should be noted that the language used in the specification has been principally selected for readability and instructional purposes and has not necessarily been selected to delineate or circumscribe the subject matter described herein.

### BRIEF DESCRIPTION OF THE DRAWINGS

So that the present disclosure can be understood in greater detail, a more particular description can be had by reference to the features of various embodiments, some of which are illustrated in the appended drawings. The appended drawings, however, merely illustrate pertinent features of the present disclosure and are therefore not necessarily to be considered limiting, for the description can admit to other effective features as the person of skill in this art will appreciate upon reading this disclosure.

FIG. 1 is a block diagram illustrating an example communication system in accordance with some embodiments.

FIG. 2A is a block diagram illustrating example elements of an encoder component in accordance with some embodiments.

FIG. 2B is a block diagram illustrating example elements of a decoder component in accordance with some embodiments.

FIG. 3 is a block diagram illustrating an example server system in accordance with some embodiments.

FIG. 4 illustrates an example transform process involving secondary transforms in accordance with some embodiments.

FIG. 5A illustrates an example video decoding process in accordance with some embodiments.

FIG. 5B illustrates an example video encoding process in accordance with some embodiments.

In accordance with common practice, the various features illustrated in the drawings are not necessarily drawn to scale, and like reference numerals can be used to denote like features throughout the specification and figures.

### DETAILED DESCRIPTION

The present disclosure describes video/image compression techniques related to selecting a reduced set of transform sets (e.g., secondary transform sets) based on coded information that includes an intra prediction mode of a current block. A residual block of the current block may have directionality and/or distributions associated with the coded information; therefore, a subset of the available transform sets may be selected to correspond to the directionality and/or distributions. Limiting the selectable transform sets to a subset of all available transform sets can include reduce coding time and/or signaling overhead. By adaptively selecting the subset of transform sets, for example, based on the corresponding intra prediction mode, a more accurate and/or efficient transform kernel that improves the quality of the coding (e.g., more accurate encoding/decoding) may be selected from a reduced set of transform sets.

### Example Systems and Devices

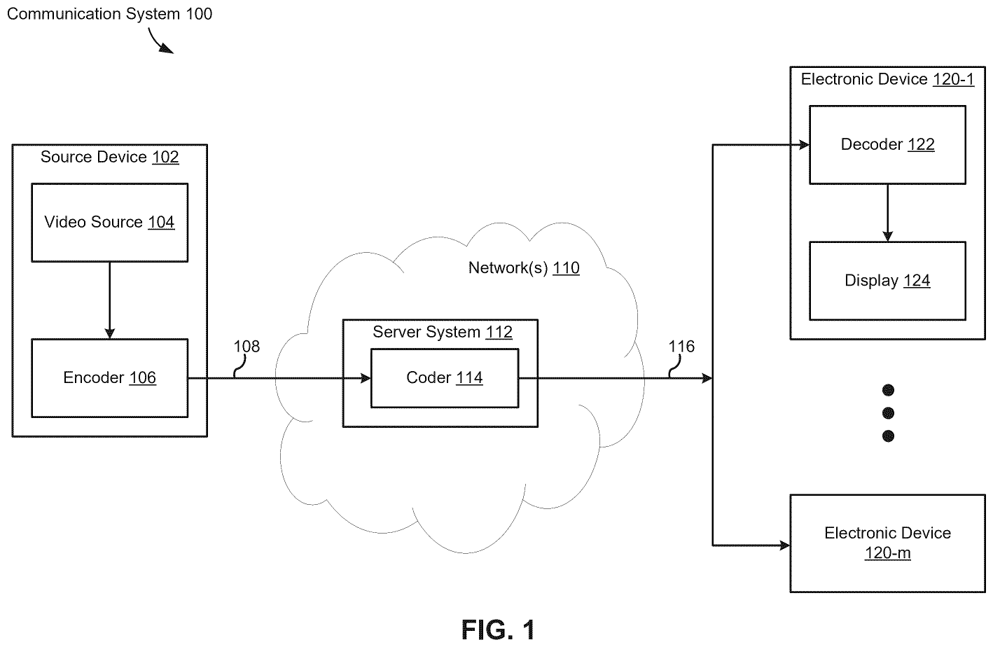

FIG. 1 is a block diagram illustrating a communication system 100 in accordance with some embodiments. The communication system 100 includes a source device 102 and a plurality of electronic devices 120 (e.g., electronic device 120-1 to electronic device 120-m) that are communicatively coupled to one another via one or more networks. In some embodiments, the communication system 100 is a streaming system, e.g., for use with video-enabled applications such as video conferencing applications, digital TV applications, and media storage and/or distribution applications.

The source device 102 includes a video source 104 (e.g., a camera component or media storage) and an encoder component 106. In some embodiments, the video source 104 is a digital camera (e.g., configured to create an uncompressed video sample stream). The encoder component 106 generates one or more encoded video bitstreams from the video stream. The video stream from the video source 104 may be high data volume as compared to the encoded video bitstream 108 generated by the encoder component 106. Because the encoded video bitstream 108 is lower data volume (less data) as compared to the video stream from the video source, the encoded video bitstream 108 requires less bandwidth to transmit and less storage space to store as compared to the video stream from the video source 104. In some embodiments, the source device 102 does not include the encoder component 106 (e.g., is configured to transmit uncompressed video to the network(s) 110).

The one or more networks 110 represents any number of networks that convey information between the source device 102, the server system 112, and/or the electronic devices 120, including for example wireline (wired) and/or wireless communication networks. The one or more networks 110 may exchange data in circuit-switched and/or packet-switched channels. Representative networks include telecommunications networks, local area networks, wide area networks and/or the Internet.

The one or more networks 110 include a server system 112 (e.g., a distributed/cloud computing system). In some embodiments, the server system 112 is, or includes, a streaming server (e.g., configured to store and/or distribute video content such as the encoded video stream from the source device 102). The server system 112 includes a coder component 114 (e.g., configured to encode and/or decode video data). In some embodiments, the coder component 114 includes an encoder component and/or a decoder component. In various embodiments, the coder component 114 is instantiated as hardware, software, or a combination thereof. In some embodiments, the coder component 114 is configured to decode the encoded video bitstream 108 and re-encode the video data using a different encoding standard and/or methodology to generate encoded video data 116. In some embodiments, the server system 112 is configured to generate multiple video formats and/or encodings from the encoded video bitstream 108. In some embodiments, the server system 112 functions as a Media-Aware Network Element (MANE). For example, the server system 112 may be configured to prune the encoded video bitstream 108 for tailoring potentially different bitstreams to one or more of the electronic devices 120. In some embodiments, a MANE is provided separate from the server system 112.

The electronic device 120-1 includes a decoder component 122 and a display 124. In some embodiments, the decoder component 122 is configured to decode the encoded video data 116 to generate an outgoing video stream that can be rendered on a display or other type of rendering device. In some embodiments, one or more of the electronic devices 120 does not include a display component (e.g., is communicatively coupled to an external display device and/or includes a media storage). In some embodiments, the electronic devices 120 are streaming clients. In some embodiments, the electronic devices 120 are configured to access the server system 112 to obtain the encoded video data 116.

The source device and/or the plurality of electronic devices 120 are sometimes referred to as “terminal devices” or “user devices.” In some embodiments, the source device 102 and/or one or more of the electronic devices 120 are instances of a server system, a personal computer, a portable device (e.g., a smartphone, tablet, or laptop), a wearable device, a video conferencing device, and/or other type of electronic device.

In example operation of the communication system 100, the source device 102 transmits the encoded video bitstream 108 to the server system 112. For example, the source device 102 may code a stream of pictures that are captured by the source device. The server system 112 receives the encoded video bitstream 108 and may decode and/or encode the encoded video bitstream 108 using the coder component 114. For example, the server system 112 may apply an encoding to the video data that is more optimal for network transmission and/or storage. The server system 112 may transmit the encoded video data 116 (e.g., one or more coded video bitstreams) to one or more of the electronic devices 120. Each electronic device 120 may decode the encoded video data 116 and optionally display the video pictures.

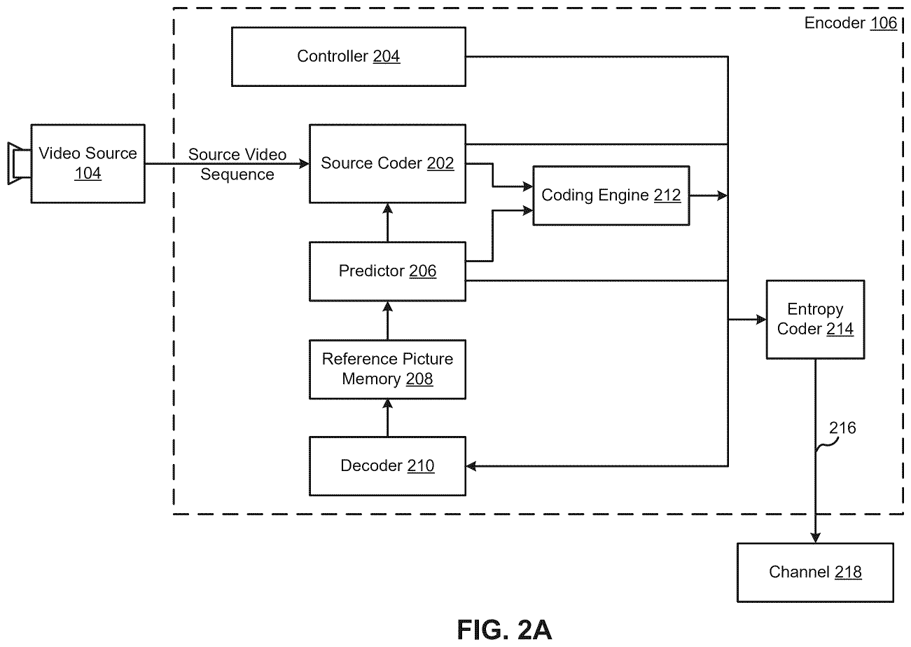

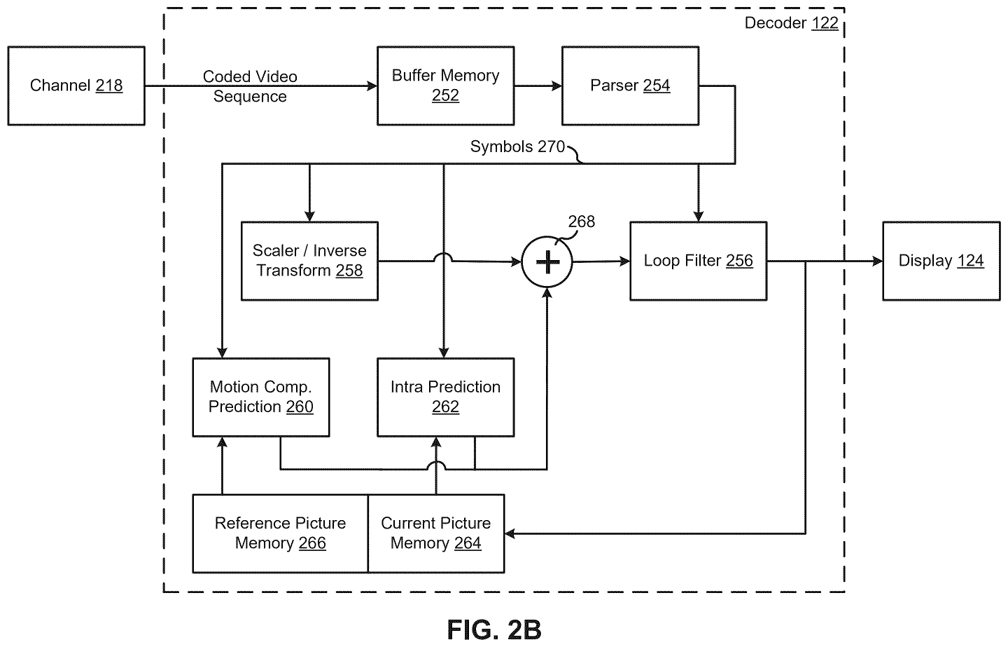

FIG. 2A is a block diagram illustrating example elements of the encoder component 106 in accordance with some embodiments. The encoder component 106 receives video data (e.g., a source video sequence) from the video source 104. In some embodiments, the encoder component includes a receiver (e.g., a transceiver) component configured to receive the source video sequence. In some embodiments, the encoder component 106 receives a video sequence from a remote video source (e.g., a video source that is a component of a different device than the encoder component 106). The video source 104 may provide the source video sequence in the form of a digital video sample stream that can be of any suitable bit depth (e.g., 8-bit, 10-bit, or 12-bit), any colorspace (e.g., BT.601 Y CrCB, or RGB), and any suitable sampling structure (e.g., Y CrCb 4:2:0 or Y CrCb 4:4:4). In some embodiments, the video source 104 is a storage device storing previously captured/prepared video. In some embodiments, the video source 104 is camera that captures local image information as a video sequence. Video data may be provided as a plurality of individual pictures that impart motion when viewed in sequence. The pictures themselves may be organized as a spatial array of pixels, where each pixel can include one or more samples depending on the sampling structure, color space, etc. in use. A person of ordinary skill in the art can readily understand the relationship between pixels and samples.

The encoder component 106 is configured to code and/or compress the pictures of the source video sequence into a coded video sequence 216 in real-time or under other time constraints as required by the application. In some embodiments, the encoder component 106 is configured to perform a conversion between the source video sequence and a bitstream of visual media data (e.g., a video bitstream). Enforcing appropriate coding speed is one function of a controller 204. In some embodiments, the controller 204 controls other functional units as described below and is functionally coupled to the other functional units. Parameters set by the controller 204 may include rate-control-related parameters (e.g., picture skip, quantizer, and/or lambda value of rate-distortion optimization techniques), picture size, group of pictures (GOP) layout, maximum motion vector search range, and so forth. A person of ordinary skill in the art can readily identify other functions of controller 204 as they may pertain to the encoder component 106 being optimized for a certain system design.

In some embodiments, the encoder component 106 is configured to operate in a coding loop. In a simplified example, the coding loop includes a source coder 202 (e.g., responsible for creating symbols, such as a symbol stream, based on an input picture to be coded and reference picture(s)), and a (local) decoder 210. The decoder 210 reconstructs the symbols to create the sample data in a similar manner as a (remote) decoder (when compression between symbols and coded video bitstream is lossless). The reconstructed sample stream (sample data) is input to the reference picture memory 208. As the decoding of a symbol stream leads to bit-exact results independent of decoder location (local or remote), the content in the reference picture memory 208 is also bit exact between the local encoder and remote encoder. In this way, the prediction part of an encoder interprets as reference picture samples the same sample values as a decoder would interpret when using prediction during decoding.

The operation of the decoder 210 can be the same as of a remote decoder, such as the decoder component 122, which is described in detail below in conjunction with FIG. 2B. Briefly referring to FIG. 2B, however, as symbols are available and encoding/decoding of symbols to a coded video sequence by an entropy coder 214 and the parser 254 can be lossless, the entropy decoding parts of the decoder component 122, including the buffer memory 252 and the parser 254 may not be fully implemented in the local decoder 210.

The decoder technology described herein, except the parsing/entropy decoding, may be to be present, in substantially identical functional form, in a corresponding encoder. For this reason, the disclosed subject matter focuses on decoder operation. Additionally, the description of encoder technologies can be abbreviated as they may be the inverse of the decoder technologies.

As part of its operation, the source coder 202 may perform motion compensated predictive coding, which codes an input frame predictively with reference to one or more previously-coded frames from the video sequence that were designated as reference frames. In this manner, the coding engine 212 codes differences between pixel blocks of an input frame and pixel blocks of reference frame(s) that may be selected as prediction reference(s) to the input frame. The controller 204 may manage coding operations of the source coder 202, including, e.g., setting of parameters and subgroup parameters used for encoding the video data.

The decoder 210 decodes coded video data of frames that may be designated as reference frames, based on symbols created by the source coder 202. Operations of the coding engine 212 may advantageously be lossy processes. When the coded video data is decoded at a video decoder (not shown in FIG. 2A), the reconstructed video sequence may be a replica of the source video sequence with some errors. The decoder 210 replicates decoding processes that may be performed by a remote video decoder on reference frames and may cause reconstructed reference frames to be stored in the reference picture memory 208. In this manner, the encoder component 106 stores copies of reconstructed reference frames locally that have common content as the reconstructed reference frames that will be obtained by a remote video decoder (absent transmission errors).

The predictor 206 may perform prediction searches for the coding engine 212. That is, for a new frame to be coded, the predictor 206 may search the reference picture memory 208 for sample data (as candidate reference pixel blocks) or certain metadata such as reference picture motion vectors, block shapes, and so on, that may serve as an appropriate prediction reference for the new pictures. The predictor 206 may operate on a sample block-by-pixel block basis to find appropriate prediction references. As determined by search results obtained by the predictor 206, an input picture may have prediction references drawn from multiple reference pictures stored in the reference picture memory 208.

Output of all aforementioned functional units may be subjected to entropy coding in the entropy coder 214. The entropy coder 214 translates the symbols as generated by the various functional units into a coded video sequence, by losslessly compressing the symbols according to technologies known to a person of ordinary skill in the art (e.g., Huffman coding, variable length coding, and/or arithmetic coding).

In some embodiments, an output of the entropy coder 214 is coupled to a transmitter. The transmitter may be configured to buffer the coded video sequence(s) as created by the entropy coder 214 to prepare them for transmission via a communication channel 218, which may be a hardware/software link to a storage device which would store the encoded video data. The transmitter may be configured to merge coded video data from the source coder 202 with other data to be transmitted, e.g., coded audio data and/or ancillary data streams (sources not shown). In some embodiments, the transmitter may transmit additional data with the encoded video. The source coder 202 may include such data as part of the coded video sequence. Additional data may comprise temporal/spatial/SNR enhancement layers, other forms of redundant data such as redundant pictures and slices, Supplementary Enhancement Information (SEI) messages, Visual Usability Information (VUI) parameter set fragments, and the like.

The controller 204 may manage operation of the encoder component 106. During coding, the controller 204 may assign to each coded picture a certain coded picture type, which may affect the coding techniques that are applied to the respective picture. For example, pictures may be assigned as an Intra Picture (I picture), a Predictive Picture (P picture), or a Bi-directionally Predictive Picture (B Picture). An Intra Picture may be coded and decoded without using any other frame in the sequence as a source of prediction. Some video codecs allow for different types of Intra pictures, including, e.g., Independent Decoder Refresh (IDR) Pictures. A person of ordinary skill in the art is aware of those variants of I pictures and their respective applications and features, and therefore they are not repeated here. A Predictive picture may be coded and decoded using intra prediction or inter prediction using at most one motion vector and reference index to predict the sample values of each block. A Bi-directionally Predictive Picture may be coded and decoded using intra prediction or inter prediction using at most two motion vectors and reference indices to predict the sample values of each block. Similarly, multiple-predictive pictures can use more than two reference pictures and associated metadata for the reconstruction of a single block.

Source pictures commonly may be subdivided spatially into a plurality of sample blocks (e.g., blocks of 4×4, 8×8, 4×8, or 16×16 samples each) and coded on a block-by-block basis. Blocks may be coded predictively with reference to other (already coded) blocks as determined by the coding assignment applied to the blocks' respective pictures. For example, blocks of I pictures may be coded non-predictively or they may be coded predictively with reference to already coded blocks of the same picture (spatial prediction or intra prediction). Pixel blocks of P pictures may be coded non-predictively, via spatial prediction or via temporal prediction with reference to one previously coded reference pictures. Blocks of B pictures may be coded non-predictively, via spatial prediction or via temporal prediction with reference to one or two previously coded reference pictures.

A video may be captured as a plurality of source pictures (video pictures) in a temporal sequence. Intra-picture prediction (often abbreviated to intra prediction) makes use of spatial correlation in a given picture, and inter-picture prediction makes uses of the (temporal or other) correlation between the pictures. In an example, a specific picture under encoding/decoding, which is referred to as a current picture, is partitioned into blocks. When a block in the current picture is similar to a reference block in a previously coded and still buffered reference picture in the video, the block in the current picture can be coded by a vector that is referred to as a motion vector. The motion vector points to the reference block in the reference picture, and can have a third dimension identifying the reference picture, in case multiple reference pictures are in use.

The encoder component 106 may perform coding operations according to a predetermined video coding technology or standard, such as any described herein. In its operation, the encoder component 106 may perform various compression operations, including predictive coding operations that exploit temporal and spatial redundancies in the input video sequence. The coded video data, therefore, may conform to a syntax specified by the video coding technology or standard being used.

FIG. 2B is a block diagram illustrating example elements of the decoder component 122 in accordance with some embodiments. The decoder component 122 in FIG. 2B is coupled to the channel 218 and the display 124. In some embodiments, the decoder component 122 includes a transmitter coupled to the loop filter 256 and configured to transmit data to the display 124 (e.g., via a wired or wireless connection).

In some embodiments, the decoder component 122 includes a receiver coupled to the channel 218 and configured to receive data from the channel 218 (e.g., via a wired or wireless connection). The receiver may be configured to receive one or more coded video sequences to be decoded by the decoder component 122. In some embodiments, the decoding of each coded video sequence is independent from other coded video sequences. Each coded video sequence may be received from the channel 218, which may be a hardware/software link to a storage device which stores the encoded video data. The receiver may receive the encoded video data with other data, e.g., coded audio data and/or ancillary data streams, that may be forwarded to their respective using entities (not depicted). The receiver may separate the coded video sequence from the other data. In some embodiments, the receiver receives additional (redundant) data with the encoded video. The additional data may be included as part of the coded video sequence(s). The additional data may be used by the decoder component 122 to decode the data and/or to more accurately reconstruct the original video data. Additional data can be in the form of, e.g., temporal, spatial, or SNR enhancement layers, redundant slices, redundant pictures, forward error correction codes, and so on.

In accordance with some embodiments, the decoder component 122 includes a buffer memory 252, a parser 254 (also sometimes referred to as an entropy decoder), a scaler/inverse transform unit 258, an intra picture prediction unit 262, a motion compensation prediction unit 260, an aggregator 268, the loop filter unit 256, a reference picture memory 266, and a current picture memory 264. In some embodiments, the decoder component 122 is implemented as an integrated circuit, a series of integrated circuits, and/or other electronic circuitry. The decoder component 122 may be implemented at least in part in software.

The buffer memory 252 is coupled in between the channel 218 and the parser 254 (e.g., to combat network jitter). In some embodiments, the buffer memory 252 is separate from the decoder component 122. In some embodiments, a separate buffer memory is provided between the output of the channel 218 and the decoder component 122. In some embodiments, a separate buffer memory is provided outside of the decoder component 122 (e.g., to combat network jitter) in addition to the buffer memory 252 inside the decoder component 122 (e.g., which is configured to handle playout timing). When receiving data from a store/forward device of sufficient bandwidth and controllability, or from an isosynchronous network, the buffer memory 252 may not be needed, or can be small. For use on best effort packet networks such as the Internet, the buffer memory 252 may be required, can be comparatively large and/or of adaptive size, and may at least partially be implemented in an operating system or similar elements outside of the decoder component 122.

The parser 254 is configured to reconstruct symbols 270 from the coded video sequence. The symbols may include, e.g., information used to manage operation of the decoder component 122, and/or information to control a rendering device such as the display 124. The control information for the rendering device(s) may be in the form of, e.g., Supplementary Enhancement Information (SEI) messages or Video Usability Information (VUI) parameter set fragments (not depicted). The parser 254 parses (entropy-decodes) the coded video sequence. The coding of the coded video sequence can be in accordance with a video coding technology or standard, and can follow principles well known to a person skilled in the art, including variable length coding, Huffman coding, arithmetic coding with or without context sensitivity, and so forth. The parser 254 may extract from the coded video sequence, a set of subgroup parameters for at least one of the subgroups of pixels in the video decoder, based upon at least one parameter corresponding to the group. Subgroups can include Groups of Pictures (GOPs), pictures, tiles, slices, macroblocks, Coding Units (CUs), blocks, Transform Units (TUs), Prediction Units (PUs) and so forth. The parser 254 may also extract, from the coded video sequence, information such as transform coefficients, quantizer parameter values, motion vectors, and so forth.

Reconstruction of the symbols 270 can involve multiple different units depending on the type of the coded video picture or parts thereof (such as: inter and intra picture, inter and intra block), and other factors. Which units are involved, and how they are involved, can be controlled by the subgroup control information that was parsed from the coded video sequence by the parser 254. The flow of such subgroup control information between the parser 254 and the multiple units below is not depicted for clarity.

The decoder component 122 can be conceptually subdivided into a number of functional units, and in some implementations, these units interact closely with each other and can, at least partly, be integrated into each other. However, for clarity, the conceptual subdivision of the functional units is maintained herein.

The scaler/inverse transform unit 258 receives quantized transform coefficients as well as control information (such as which transform to use, block size, quantization factor, and/or quantization scaling matrices) as symbol(s) 270 from the parser 254. The scaler/inverse transform unit 258 can output blocks including sample values that can be input into the aggregator 268.

In some cases, the output samples of the scaler/inverse transform unit 258 pertain to an intra coded block; that is: a block that is not using predictive information from previously reconstructed pictures, but can use predictive information from previously reconstructed parts of the current picture. Such predictive information can be provided by the intra picture prediction unit 262. The intra picture prediction unit 262 may generate a block of the same size and shape as the block under reconstruction, using surrounding already-reconstructed information fetched from the current (partly reconstructed) picture from the current picture memory 264. The aggregator 268 may add, on a per sample basis, the prediction information the intra picture prediction unit 262 has generated to the output sample information as provided by the scaler/inverse transform unit 258.

In other cases, the output samples of the scaler/inverse transform unit 258 pertain to an inter coded, and potentially motion-compensated, block. In such cases, the motion compensation prediction unit 260 can access the reference picture memory 266 to fetch samples used for prediction. After motion compensating the fetched samples in accordance with the symbols 270 pertaining to the block, these samples can be added by the aggregator 268 to the output of the scaler/inverse transform unit 258 (in this case called the residual samples or residual signal) so to generate output sample information. The addresses within the reference picture memory 266, from which the motion compensation prediction unit 260 fetches prediction samples, may be controlled by motion vectors. The motion vectors may be available to the motion compensation prediction unit 260 in the form of symbols 270 that can have, e.g., X, Y, and reference picture components. Motion compensation may also include interpolation of sample values as fetched from the reference picture memory 266, e.g., when sub-sample exact motion vectors are in use, motion vector prediction mechanisms.

The output samples of the aggregator 268 can be subject to various loop filtering techniques in the loop filter unit 256. Video compression technologies can include in-loop filter technologies that are controlled by parameters included in the coded video bitstream and made available to the loop filter unit 256 as symbols 270 from the parser 254, but can also be responsive to meta-information obtained during the decoding of previous (in decoding order) parts of the coded picture or coded video sequence, as well as responsive to previously reconstructed and loop-filtered sample values. The output of the loop filter unit 256 can be a sample stream that can be output to a render device such as the display 124, as well as stored in the reference picture memory 266 for use in future inter-picture prediction.

Certain coded pictures, once reconstructed, can be used as reference pictures for future prediction. Once a coded picture is reconstructed and the coded picture has been identified as a reference picture (by, e.g., parser 254), the current reference picture can become part of the reference picture memory 266, and a fresh current picture memory can be reallocated before commencing the reconstruction of the following coded picture.

The decoder component 122 may perform decoding operations according to a predetermined video compression technology that may be documented in a standard, such as any of the standards described herein. The coded video sequence may conform to a syntax specified by the video compression technology or standard being used, in the sense that it adheres to the syntax of the video compression technology or standard, as specified in the video compression technology document or standard and specifically in the profiles document therein. Also, for compliance with some video compression technologies or standards, the complexity of the coded video sequence may be within bounds as defined by the level of the video compression technology or standard. In some cases, levels restrict the maximum picture size, maximum frame rate, maximum reconstruction sample rate (measured in, e.g., megasamples per second), maximum reference picture size, and so on. Limits set by levels can, in some cases, be further restricted through Hypothetical Reference Decoder (HRD) specifications and metadata for HRD buffer management signaled in the coded video sequence.

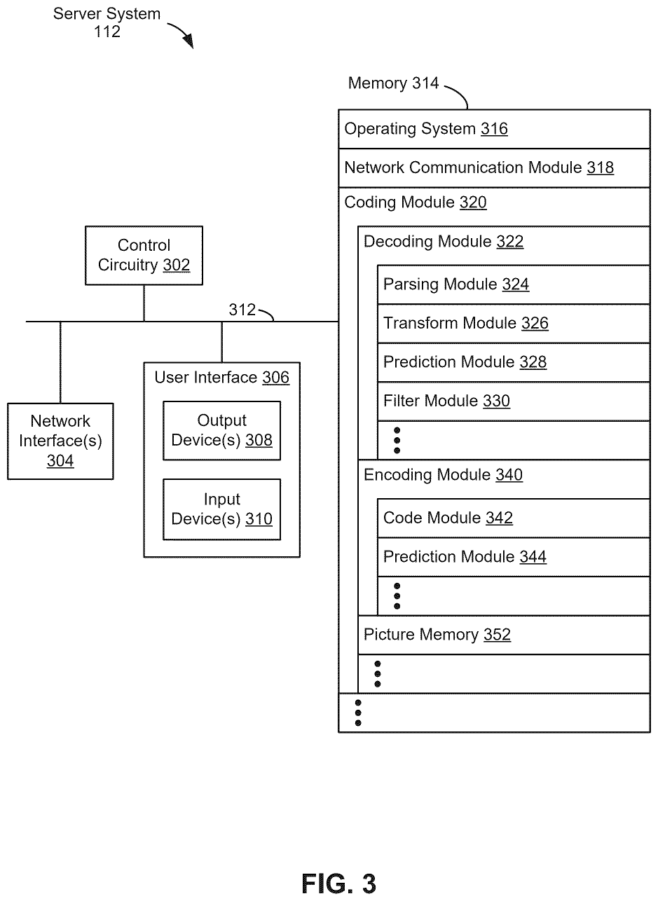

FIG. 3 is a block diagram illustrating the server system 112 in accordance with some embodiments. The server system 112 includes control circuitry 302, one or more network interfaces 304, a memory 314, a user interface 306, and one or more communication buses 312 for interconnecting these components. In some embodiments, the control circuitry 302 includes one or more processors (e.g., a CPU, GPU, and/or DPU). In some embodiments, the control circuitry includes field-programmable gate array(s), hardware accelerators, and/or integrated circuit(s) (e.g., an application-specific integrated circuit).

The network interface(s) 304 may be configured to interface with one or more communication networks (e.g., wireless, wireline, and/or optical networks). The communication networks can be local, wide-area, metropolitan, vehicular and industrial, real-time, delay-tolerant, and so on. Examples of communication networks include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CANBus, and so forth. Such communication can be unidirectional, receive only (e.g., broadcast TV), unidirectional send-only (e.g., CANbus to certain CANbus devices), or bi-directional (e.g., to other computer systems using local or wide area digital networks). Such communication can include communication to one or more cloud computing networks.

The user interface 306 includes one or more output devices 308 and/or one or more input devices 310. The input device(s) 310 may include one or more of: a keyboard, a mouse, a trackpad, a touch screen, a data-glove, a joystick, a microphone, a scanner, a camera, or the like. The output device(s) 308 may include one or more of: an audio output device (e.g., a speaker), a visual output device (e.g., a display or monitor), or the like.

The memory 314 may include high-speed random-access memory (such as DRAM, SRAM, DDR RAM, and/or other random access solid-state memory devices) and/or non-volatile memory (such as one or more magnetic disk storage devices, optical disk storage devices, flash memory devices, and/or other non-volatile solid-state storage devices). The memory 314 optionally includes one or more storage devices remotely located from the control circuitry 302. The memory 314, or, alternatively, the non-volatile solid-state memory device(s) within the memory 314, includes a non-transitory computer-readable storage medium. In some embodiments, the memory 314, or the non-transitory computer-readable storage medium of the memory 314, stores the following programs, modules, instructions, and data structures, or a subset or superset thereof:
an operating system 316 that includes procedures for handling various basic system services and for performing hardware-dependent tasks;
a network communication module 318 that is used for connecting the server system 112 to other computing devices via the one or more network interfaces 304 (e.g., via wired and/or wireless connections);
a coding module 320 for performing various functions with respect to encoding and/or decoding data, such as video data. In some embodiments, the coding module 320 is an instance of the coder component 114. The coding module 320 including, but not limited to, one or more of:
   a decoding module 322 for performing various functions with respect to decoding encoded data, such as those described previously with respect to the decoder component 122; and
   an encoding module 340 for performing various functions with respect to encoding data, such as those described previously with respect to the encoder component 106; and
a picture memory 352 for storing pictures and picture data, e.g., for use with the coding module 320. In some embodiments, the picture memory 352 includes one or more of: the reference picture memory 208, the buffer memory 252, the current picture memory 264, and the reference picture memory 266.

In some embodiments, the decoding module 322 includes a parsing module 324 (e.g., configured to perform the various functions described previously with respect to the parser 254), a transform module 326 (e.g., configured to perform the various functions described previously with respect to the scalar/inverse transform unit 258), a prediction module 328 (e.g., configured to perform the various functions described previously with respect to the motion compensation prediction unit 260 and/or the intra picture prediction unit 262), and a filter module 330 (e.g., configured to perform the various functions described previously with respect to the loop filter 256).

In some embodiments, the encoding module 340 includes a code module 342 (e.g., configured to perform the various functions described previously with respect to the source coder 202 and/or the coding engine 212) and a prediction module 344 (e.g., configured to perform the various functions described previously with respect to the predictor 206). In some embodiments, the decoding module 322 and/or the encoding module 340 include a subset of the modules shown in FIG. 3. For example, a shared prediction module is used by both the decoding module 322 and the encoding module 340.

Each of the above identified modules stored in the memory 314 corresponds to a set of instructions for performing a function described herein. The above identified modules (e.g., sets of instructions) need not be implemented as separate software programs, procedures, or modules, and thus various subsets of these modules may be combined or otherwise re-arranged in various embodiments. For example, the coding module 320 optionally does not include separate decoding and encoding modules, but rather uses a same set of modules for performing both sets of functions. In some embodiments, the memory 314 stores a subset of the modules and data structures identified above. In some embodiments, the memory 314 stores additional modules and data structures not described above.

Although FIG. 3 illustrates the server system 112 in accordance with some embodiments, FIG. 3 is intended more as a functional description of the various features that may be present in one or more server systems rather than a structural schematic of the embodiments described herein. In practice, items shown separately could be combined and some items could be separated. For example, some items shown separately in FIG. 3 could be implemented on single servers and single items could be implemented by one or more servers. The actual number of servers used to implement the server system 112, and how features are allocated among them, will vary from one implementation to another and, optionally, depends in part on the amount of data traffic that the server system handles during peak usage periods as well as during average usage periods.

### Example Coding Techniques

The coding processes and techniques described below may be performed at the devices and systems described above (e.g., the source device 102, the server system 112, and/or the electronic device 120). As described above, an intra prediction and/or inter prediction is performed on a current block to generate a prediction block. A residual block that includes a set of residues is generated by subtracting the prediction block from the current block.

Transform coding may be applied to the residual block to remove potential spatial correlations. A transform may refer to a primary transform (e.g., a multiple transform selection (MTS) or a non-separable primary transform (NSPT)), or a secondary transform (e.g., a non-separable secondary transform (NSST) or a low frequency non-separable transform (LFNST)). In some embodiments, compressing a video frame with intra prediction, includes applying a primary transform on the residual block. Thereafter, one or more secondary transform kernels of an intra secondary transform set (IST) are further applied on top of the coefficients obtained as the output of primary transform to reduce the redundancy. As an example, there may be 7 sets of secondary transform kernels, and each set may contain 3 secondary transform kernels. In some embodiments, after an IST kernel is selected, the IST set index and the kernel index are entropy coded into the bitstream. Otherwise, if kernel index is 0, no secondary transform will be applied.

A primary transform may belong to the family of sinusoidal transforms (DCT's, DST's, flipped versions of DCT's and ADST's). DCT may refer to any transforms that use a transform kernel originating from the discrete cosine transform basis (e.g., DCT type 2), and DST/ADST may refer to any transforms that use a transform kernel originating from the discrete sine transform basis (e.g., DST type 4 or 7). An example primary transform may belong to the family of generalized line graph transforms (LGT) or it may be a training-based kernel. An example secondary transform set may be a grouping of one or more secondary transform kernels. Unique or common secondary transform sets may be defined for each primary transform type, and/or intra or inter mode type. An example block may be a transform block.

An end of block (EOB) value corresponds to the position of the last significant (e.g., non-zero) coefficient following a given coefficient scanning order in a coded block. All coefficients in positions beyond the EOB are zero for a given coefficient scanning order. In some embodiments, if a non-separable secondary transform kernel of size M×N is applied to a coded block, the EOB value is ≤M.

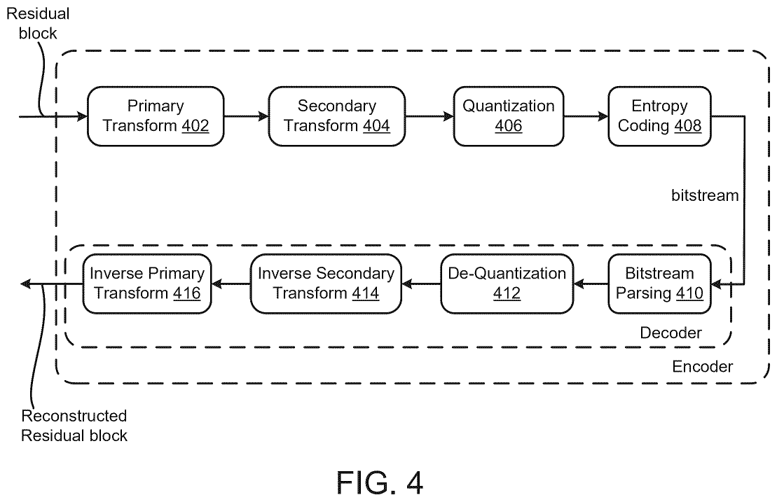

The use of IST in the encoding and decoding process is illustrated in FIG. 4. In some embodiments, a current block includes a set of samples (e.g., pixel blocks) while a prediction block includes a set of predictions that correspond to the set of samples. In some embodiments, the prediction block is subtracted from the current block to generate a residual block that includes a set of residues. For example, respective differences are calculated between each sample and the corresponding prediction. FIG. 4 shows a primary transform 402 being applied to a residual block (e.g., corresponding to an intra prediction block). A secondary transform 404 is applied to the output of the primary transform 402. A secondary transform is an additional transform process subsequent to the primary transform. For example, in NSST, a non-separable secondary transform is applied to lower-frequency coefficients so that computational complexity for non-separable transform may be reduced. Quantization 406 is applied to the output of the secondary transform 404 and the resulting quantized coefficients are entropy encoded 408 and signaled via a video bitstream. The video bitstream is parsed 410 (e.g., at a decoder) and the quantized coefficients are de-quantized 412. An inverse secondary transform 414 is applied to the de-quantized data and an inverse primary transform 416 is applied to the output of the secondary transform 414. In this way, a reconstructed residual block is generated.

Notably, the transforms performed during decoding of the video bitstream may be inverses of the transformed performed during encoding of the video bitstream, and are sometimes referred to as “inverse transforms”. For simplicity, the transformations described herein may be referred to as “transforms” whether performed during encoding or decoding.

In some embodiments, the residual block undergoes one or more transformations and quantization to generate a set of residual coefficients. The set of residual coefficients may be transmitted from an encoder component to a decoder component. The set of residual coefficients undergo a reverse quantization and reverse transformation to generate a reconstructed residual block. The reconstructed residual block is combined with the predicted block (e.g., reconstructed residues of the reconstructed residual block are added to predictions of the prediction block) to generate a reconstructed block corresponding to the current block.

In some embodiments, previously decoded information is used to select a subset of all available IST sets for the current block. In some embodiments, the previously decoded information includes one or more of: the intra or inter prediction mode, primary transform type, EOB value, block size, block aspect ratio, or the like.

Using the previously decoded information may allow a secondary transform set to be adaptively selected for a residual block of the current block. By using a subset of all available secondary transform sets, fewer bits may be used to signal the selected secondary transform set from the subset of secondary transform sets.

In some embodiments, a decoded set index is used as an offset to obtain an actual set index from the selected subset of all available IST sets, and optionally implemented as a look up table.

In some embodiments, a size of the subset, selected from all available IST sets, is fixed. In some embodiments, if N IST sets are available, only M (M<=N) IST sets may be selected and signaled for each intra mode, where M is less than or equal to N. By using only a subset of all available IST sets, fewer bits may be used to signal the index associated with the selected IST set. As an example, if 7 IST sets are available, only 4 sets may be selected and signaled for each intra mode. Only at most 2 bits is necessary to represent the index when there are 4 possible IST sets in the subset, as opposed to all 7 IST sets. In some embodiments, the index may correspond to a different IST set for each intra mode.

In some embodiments, the size of the IST sets depends on the intra prediction mode. In some embodiments, the size of IST sets depends on whether the delta angle is 0 for the intra directional prediction. For an intra directional prediction having a delta angle of 0, the intra direction corresponds to the primary direction. As an example, in some embodiments, the size of the IST sets may be smaller for directional intra prediction modes with non-zero delta angles, compared to directional intra prediction modes having a delta angle of 0. For example, based on the content associated with the current block, intra prediction modes having non-zero delta angles may provide higher coding accuracy than an intra prediction mode having a delta angle of 0, so that increasing the size of the IST sets may not lead to much additional increase in coding accuracy. As a result of the tradeoff between coding accuracy and the higher signaling overhead, the size of the IST sets may be smaller for directional intra prediction modes having non-zero delta angles. Different directional intra prediction modes may have different transform kernel preferences. By offering the ability to select different transform kernels for different directional intra predictions, characteristics of the current block can be more accurately represented, which may improve coding efficiency.

In some embodiments, the size of the IST sets depends on whether the intra prediction mode is directional intra prediction mode or not. For example, for an intra prediction mode is non-directional mode, such as DC, SMOOTH, or PLANAR, more IST sets are allowed. In some embodiments, increasing the size of the IST sets may lead to an increase in coding accuracy, by finding a more suitable secondary transform within the larger IST sets, for non-directional intra prediction modes. For example, when a non-directional intra mode is used, the residual block may have a distribution that is more aligned with an IST kernel in the larger IST set, which may provide a more efficient basis function for the residual block and be more aligned with the statistics of the residual block. Thus, coding efficiency may be improved by using more varied transform kernels for different prediction residuals, due to the diverse nature of image or video content.

In some embodiments, the size of IST sets depends on the primary transform type. In some embodiments, the size of IST sets depends on whether DCT is selected as either one direction of the primary transform. For example, the size of IST sets is larger when the primary transform type is DCT-DCT. For example, increasing the size of the IST sets may lead to an increase in coding accuracy for outputs from the DCT-DCT primary transform. As a result of the tradeoff between coding accuracy and the higher signaling overhead, the size of the IST sets may be larger when the primary transform type is DCT-DCT.

In some embodiments, the size of IST sets if different for different EOB values. In some embodiments, the IST set index is signaled for a block only if EOB≥M. Otherwise, IST is not applied. For example, possible values of M include 1, 2, . . . 64, or another value. In some embodiments, the EOB values may correspond to different frequency transform coefficient regions where additional secondary transforms may become applicable. In some embodiments, EOB groups may be defined, and the EOB group used as indicator for determining IST set size. For example, EOB values in ranges of 1-8, 9-16, 17-32, 33-64 may be mapped to EOB groups 0, 1, 2 and 3. In some embodiments, the sizes of the IST sets increase with EOB values.

In some embodiments, the size of the IST sets may depend on the block size of current block. In some embodiments, the size of the IST sets is smaller when block width or block height is less than or equal to one threshold T1. In some embodiments, T1 is 4.

In some embodiments, the context for signaling the index of the IST set depends on the block size, transform type or EOB values. In some embodiments, the entropy coding context for the IST set index is derived based on the EOB group.

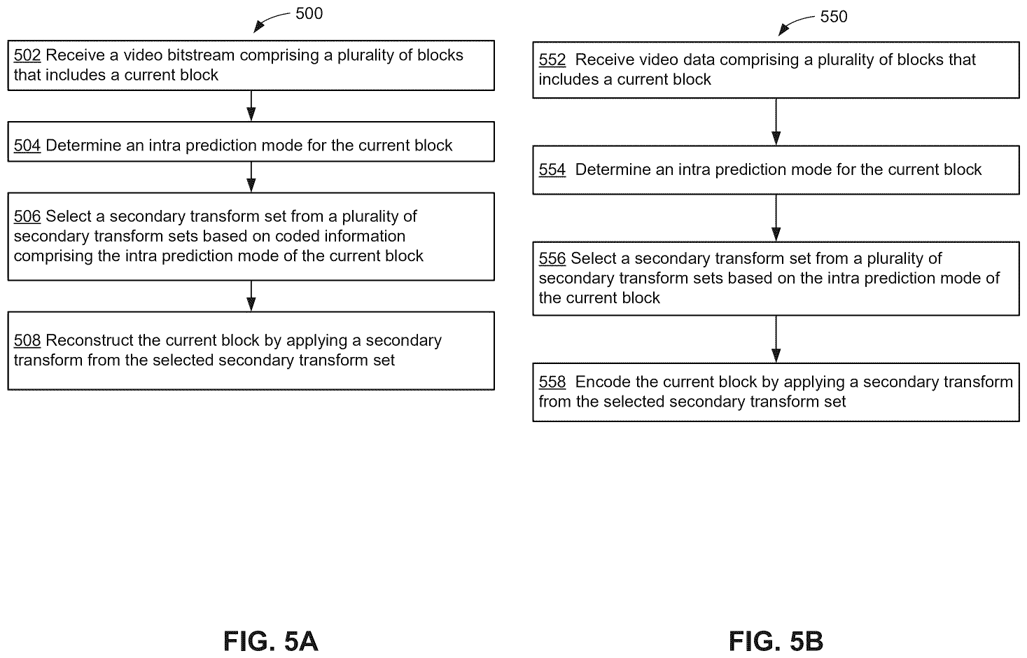

FIG. 5A is a flow diagram illustrating a method 500 of decoding video in accordance with some embodiments. The method 500 may be performed at a computing system (e.g., the server system 112, the source device 102, or the electronic device 120) having control circuitry and memory storing instructions for execution by the control circuitry. In some embodiments, the method 500 is performed by executing instructions stored in the memory (e.g., the memory 314) of the computing system.

The system receives (502) a video bitstream comprising a plurality of blocks that includes a current block. The system determines (504) an intra prediction mode for the current block. The system selects (506) a secondary transform set from a plurality of secondary transform sets based on coded information comprising the intra prediction mode of the current block. The system reconstructs (508) the current block by applying a secondary transform from the selected secondary transform set (e.g., a transform that is the inverse of a secondary transform applied during encoding). In this way, previously decoded information may be used to select a subset of all available IST sets for the current block. For example, when the current block is coded by a first intra prediction mode, a subset of all available secondary transform sets is available for selection (e.g., as described above with respect to FIG. 4).

In some embodiments, the previously decoded information may include the intra or inter prediction mode, primary transform type, EOB value, block size, block aspect ratio, or the like.

In some embodiments, a decoded set index is used as an offset to get the actual set index from the selected subset of all available IST sets, which may be implemented as a look up table. In some embodiments, the size of the subset of all available IST sets is fixed.

In some embodiments, if N IST sets are available, only M (M<=N) IST sets are selected and signaled for each intra mode. Thus, fewer bits may be required for signaling the index. In some embodiments, if 7 IST sets are available, only 4 sets may be selected and signaled for each intra mode, which only require at most 2 bits to represent the index. For each intra mode, the index may correspond to a different IST set.

In some embodiments, the size of IST sets may depend on the intra prediction mode. In some embodiments, the size of IST sets depends on whether the delta angle is 0 for the intra directional prediction. In some embodiments, the size of IST sets is smaller for directional intra prediction modes with non-zero delta angles.

In some embodiments, the size of the IST sets depends on whether the intra prediction mode is a directional intra prediction mode or not. In some embodiments, if the intra mode is a non-directional mode, such as DC or SMOOTH, or PLANAR, more IST sets are allowed.

In some embodiments, the size of IST sets may depend on the primary transform type. In some embodiments, the size of IST sets depends on whether DCT is selected for either one direction of the primary transform. In some embodiments, the size of IST sets is larger when the primary transform type is DCT-DCT. In some embodiments, the size of IST sets may be different for different end of block (EOB) value. In some embodiments, IST set index is signaled for a block only if EOB≥M. In some embodiments, possible values of M include 1, 2, . . . 64, or another value. In some embodiments, EOB groups may be defined, and the EOB group used as indicator for determining a IST set size. For example, EOB values in ranges 1-8, 9-16, 17-32, 33-64 may be mapped to EOB groups 0, 1, 2 and 3.

In some embodiments, the size of the IST sets may depend on the block size of current block. In some embodiments, the size of the IST sets is smaller when block width or block height is less than or equal to one threshold T1. For example, T1 may be set to 4.

In some embodiments, the context for signaling the index of IST set depends on the block size, transform type or EOB values. In some embodiments, the EOB group is used as context for signaling IST set index.

FIG. 5B is a flow diagram illustrating a method 550 of encoding video in accordance with some embodiments. The method 550 may be performed at a computing system (e.g., the server system 112, the source device 102, or the electronic device 120) having control circuitry and memory storing instructions for execution by the control circuitry. In some embodiments, the method 550 is performed by executing instructions stored in the memory (e.g., the memory 314) of the computing system. In some embodiments, the method 550 is performed by a same system as the method 500 described above.

The system receives (552) video data that includes a plurality of blocks that includes a current block. The system determines (554) an intra prediction mode for the current block. The system selects (556) a secondary transform set from a plurality of secondary transform sets based on the intra prediction mode of the current block. The system encodes (558) the current block by applying a secondary transform from the selected secondary transform set. As described previously, the encoding process may mirror the decoding processes described herein (e.g., the transform selection embodiments described above). For brevity, those details are not repeated here.

Although FIGS. 5A and 5B illustrate a number of logical stages in a particular order, stages which are not order dependent may be reordered and other stages may be combined or broken out. Some reordering or other groupings not specifically mentioned will be apparent to those of ordinary skill in the art, so the ordering and groupings presented herein are not exhaustive. Moreover, it should be recognized that the stages could be implemented in hardware, firmware, software, or any combination thereof.

Turning now to some example embodiments.

Simulation data on AVM v8 anchor for all-intra and random access configurations has shown that simplifying the IST for AVM by reducing the number of IST sets to 4 IST sets provides for experiments that exclude screen content sequences class B2, 13% encoding time saving and only 0.12% coding loss for All Intra mode, 4% encoding time saving and only 0.03% coding loss for Random Access mode, and 4% encoding time saving with 0.06% coding loss for Low Delay mode. For experiments that include only class B2, results show 5% encoding time saving and 0.09% coding gain for All Intra mode, 3% encoding time saving and only 0.20% coding gain for Random Access mode, and 2% encoding time saving with 0.03% coding loss for Low Delay mode.

(A1) In one aspect, some embodiments include a method (e.g., the method 500) of video decoding. In some embodiments, the method is performed at a computing system (e.g., the server system 112) having memory and control circuitry. In some embodiments, the method is performed at a source coding component (e.g., the source coder 202), a coding engine (e.g., the coding engine 212), and/or an entropy coder (e.g., the entropy coder 214). The method includes: (i) receiving a video bitstream (e.g., a coded video sequence) comprising a plurality of blocks that includes a current block; (ii) determining an intra prediction mode for the current block; (iii) selecting a secondary transform set from a plurality of secondary transform sets based on coded information comprising the intra prediction mode of the current block; and (iv) reconstructing the current block by applying a secondary transform from the selected secondary transform set. In some embodiments, the secondary transform set is selected based on previously-decoded information at a decoding component. For example, previously decoded information may be used to select a subset of all available IST sets for the current block. In some embodiments, the plurality of secondary transform sets is a plurality of intra secondary transform (IST) sets. In some embodiments, a primary transform set is selected from a plurality of primary transform sets based on coded information. For example, the primary transform set (or a non-separable transform set) may be selected in a same manner as the secondary transform set described herein. As an example, the plurality of secondary transform sets may consist of 7 sets.

(A2) In some embodiments of A1, selecting a secondary transform set from a plurality of secondary transform sets comprises: (i) identifying a secondary transform index based on the coded information; and (ii) identifying the secondary transform set from the plurality of secondary transform sets using the secondary transform index and a lookup table. For example, a decoded set index may be used as an offset to get the actual set index from the selected subset of all available IST sets, which could be implemented as a lookup table.

(A3) In some embodiments of A1 or A2, each secondary transform set in the plurality of secondary transform sets has a fixed number of transforms. For example, the size of the subset of all available IST sets may be fixed. As an example, each transform set may include 3 kernels.

(A4) In some embodiments of A3, each secondary transform set in the plurality of secondary transform sets has a same number of transforms. For example, only M out of N available IST sets (M<=N) may be selected and signaled for each intra mode.

(A5) In some embodiments of any of A1-A4, the plurality of secondary transform sets is less than all of the available secondary transform sets. For example, if 7 IST sets are available, only 4 sets may be selected and signaled for each intra mode, which requires at most 2 bits to represent the index. For each intra mode, the index may correspond to a different IST set. For example, the same index value may correspond to different transform sets for blocks having different prediction modes.

(A6) In some embodiments of any of A1-A5, the coded information further comprises at least one of: an inter prediction mode for the current block, a primary transform type for the current block, an end-of-block value for the current block, a block size of the current block, and an aspect ratio of the current block. For example, the previously decoded information may include the intra or inter prediction mode, primary transform type, EOB value, block size, and/or block aspect ratio.

(A7) In some embodiments of any of A1-A6, a number of secondary transform sets in the plurality of secondary transform sets is based on the intra prediction mode of the current block. For example, the size of IST sets may depend on the intra prediction mode.

(A8) In some embodiments of A7, the number of the secondary transform sets is based on a delta angle of the intra prediction mode. For example, the size of the IST sets may depend on whether the delta angle is 0 for the intra directional prediction. In some embodiments, the size of the selected secondary transform set is smaller for non-zero delta angles as compared to zero delta angles. For example, the size of IST sets is smaller for directional intra prediction modes with non-zero delta angles.

(A9) In some embodiments of A7, the number of the secondary transform sets is based on whether the intra prediction mode is a directional mode. For example, the size of the IST sets may depend on whether the intra prediction mode is directional intra prediction mode or not. In an example, if the intra mode is non-directional mode, such as DC or SMOOTH, or PLANAR, then more IST sets are allowed.

(A10) In some embodiments of any of A1-A9, a number of secondary transform sets in the plurality of secondary transform sets is based on a primary transform type for the current block. For example, the size of IST sets may depend on the primary transform type.

(A11) In some embodiments of A10, the number of secondary transform sets is based on whether the primary transform type includes a discrete cosine transform (DCT). For example, the size of IST sets depends on whether DCT is selected as either one direction of primary transform. As one example, the size of IST sets is larger when the primary transform type is DCT-DCT.

(A12) In some embodiments of any of A1-A11, a number of secondary transform sets in the plurality of secondary transform sets is based on an end-of-block (EOB) value for the current block. For example, the size of IST sets may be different for different EOB values.

(A13) In some embodiments of A12, an index is signaled for the selected secondary transform set when the EOB value is greater than a threshold amount. For example, IST set index may be signaled for a block only if EOB≥M. In some embodiments, an index is not signaled for the selected secondary transform set in accordance with the EOB value being less than a threshold amount. In some embodiments, an index is signaled for the selected secondary transform set in accordance with the EOB value being greater than the threshold amount.

(A14) In some embodiments of A13, the threshold amount is an integer in a range of 1 to 64. For example, possible values of M include but not limited to 1, 2, . . . , 64.

(A15) In some embodiments of A12, the number of secondary transform sets in the plurality of secondary transform sets is based on the EOB value being within an EOB group of a plurality of EOB groups. For example, EOB groups may be defined, and the EOB group may be used as indicator for determining IST set size. For example, EOB values in range 1-8, 9-16, 17-32, 33-64 may be mapped to EOB groups 0, 1, 2 and 3.

(A16) In some embodiments of any of A1-A15, a number of secondary transform sets in the plurality of secondary transform sets is based on a block size of the current block. For example, the size of the IST sets may depend on the block size of current block.

(A17) In some embodiments of A16, the number of secondary transform sets is based on whether a dimension of the current block is less than a threshold value. For example, the size of the IST sets may be smaller when block width or block height is less than or equal to one threshold T1. T1 may be set to 3, 4, or 5.

(A18) In some embodiments of any of A1-A17, the method includes, entropy decoding a syntax element of the video bitstream to determine an index for the secondary transform set, where a context for the entropy decoding is based on at least one of: a block size of the current block, a transform type for the current block, and an EOB value for the current block. For example, the context for signaling the index of IST set may depend on the block size, transform type, or EOB values. As an example, the EOB group may be used as context for signaling the IST set index.

(B1) In another aspect, some embodiments include a method (e.g., the method 550) of video encoding. In some embodiments, the method is performed at a computing system (e.g., the server system 112) having memory and one or more processors. In some embodiments, the method is performed at a coding module (e.g., the coding module 320). The method includes: (i) receiving video data comprising a plurality of blocks that includes a current block; (ii) determining an intra prediction mode for the current block; (iii) selecting a secondary transform set from a plurality of secondary transform sets based on the intra prediction mode of the current block; and (iv) encoding the current block by applying a secondary transform from the selected secondary transform set. In some embodiments, the secondary transform set is signaled in a video bitstream (e.g., using an index value). In some embodiments, an index for the secondary transform set is entropy encoded and signaled in the video bitstream. In some embodiments, a context used for the entropy encoding is based on coded information of the current block.

(C1) In another aspect, some embodiments include a method of visual media data processing. In some embodiments, the method is performed at a computing system (e.g., the server system 112) having memory and control circuitry. In some embodiments, the method is performed at a coding module (e.g., the coding module 320). The method includes: (i) receiving video data comprising a plurality of blocks that includes a current block; (ii) determining an intra prediction mode for the current block; (iii) selecting a secondary transform set from a plurality of secondary transform sets based on the intra prediction mode of the current block; and (iv) encoding the current block by applying a secondary transform from the selected secondary transform set. The video bitstream comprises the encoded current block. In some embodiments, the video bitstream comprises an indicator indicating an index value for the secondary transform set.

(D1) In another aspect, some embodiments include a method of processing visual media data. In some embodiments, the method is performed at a computing system (e.g., the server system 112) having memory and control circuitry. In some embodiments, the method is performed at a coding module (e.g., the coding module 320). In some embodiments, the method is performed at a source coding component (e.g., the source coder 202), a coding engine (e.g., the coding engine 212), and/or an entropy coder (e.g., the entropy coder 214). The method includes (i) obtaining a source video sequence that comprises a plurality of frames; and (ii) performing a conversion between the source video sequence and a video bitstream of visual media data according to a format rule, where the video bitstream comprises a plurality of encoded blocks including a current block; and where the format rule specifies that: (a) an intra prediction mode is to be determined for the current block; (b) a secondary transform set is to be selected from a plurality of secondary transform sets based on the intra prediction mode of the current block; and (c) the current block is to be reconstructed by applying a secondary transform from the selected secondary transform set.

In another aspect, some embodiments include a computing system (e.g., the server system 112) including control circuitry (e.g., the control circuitry 302) and memory (e.g., the memory 314) coupled to the control circuitry, the memory storing one or more sets of instructions configured to be executed by the control circuitry, the one or more sets of instructions including instructions for performing any of the methods described herein (e.g., A1-A18, B1, C1, and D1 above).

In yet another aspect, some embodiments include a non-transitory computer-readable storage medium storing one or more sets of instructions for execution by control circuitry of a computing system, the one or more sets of instructions including instructions for performing any of the methods described herein A1-A18, B1, C1, and D1 above).

Unless otherwise specified, any of the syntax elements (e.g., indicators) described herein may be high-level syntax (HLS). As used herein, HLS is signaled at a level that is higher than a block level. For example, HLS may correspond to a sequence level, a frame level, a slice level, or a tile level. As another example, HLS elements may be signaled in a video parameter set (VPS), a sequence parameter set (SPS), a picture parameter set (PPS), an adaptation parameter set (APS), a slice header, a picture header, a tile header, and/or a CTU header.

It will be understood that, although the terms “first,” “second,” etc. may be used herein to describe various elements, these elements should not be limited by these terms. These terms are only used to distinguish one element from another. The terminology used herein is for the purpose of describing particular embodiments only and is not intended to be limiting of the claims. As used in the description of the embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “when” can be construed to mean “if” or “upon” or “in response to determining” or “in accordance with a determination” or “in response to detecting” that a stated condition precedent is true, depending on the context. Similarly, the phrase “if it is determined [that a stated condition precedent is true]” or “if [a stated condition precedent is true]” or “when [a stated condition precedent is true]” can be construed to mean “upon determining” or “in response to determining” or “in accordance with a determination” or “upon detecting” or “in response to detecting” that the stated condition precedent is true, depending on the context. As used herein, N refers to a variable number. Unless explicitly stated, different instances of N may refer to the same number (e.g., the same integer value, such as the number 2) or different numbers.

The foregoing description, for purposes of explanation, has been described with reference to specific embodiments. However, the illustrative discussions above are not intended to be exhaustive or limit the claims to the precise forms disclosed. Many modifications and variations are possible in view of the above teachings. The embodiments were chosen and described in order to best explain principles of operation and practical applications, to thereby enable others skilled in the art.

What is claimed is:

1. A method of video decoding performed at a computing system having memory and one or more processors, the method comprising:
receiving a video bitstream comprising a plurality of blocks that includes a current block;
determining an intra prediction mode for the current block;
selecting a secondary transform set from a plurality of secondary transform sets based on coded information comprising the intra prediction mode of the current block; and
reconstructing the current block by applying a secondary transform from the selected secondary transform set.

2. The method of claim 1, wherein selecting a secondary transform set from a plurality of secondary transform sets comprises:
identifying a secondary transform index based on the coded information; and
identifying the secondary transform set from the plurality of secondary transform sets using the secondary transform index and a lookup table.

3. The method of claim 1, wherein each secondary transform set in the plurality of secondary transform sets has a fixed number of transforms.

4. The method of claim 3, wherein each secondary transform set in the plurality of secondary transform sets has a same number of transforms.

5. The method of claim 1, wherein the plurality of secondary transform sets is less than all available secondary transform sets.

6. The method of claim 1, wherein the coded information further comprises at least one of: an inter prediction mode for the current block, a primary transform type for the current block, an end-of-block value for the current block, a block size of the current block, and an aspect ratio of the current block.

7. The method of claim 1, wherein a number of secondary transform sets in the plurality of secondary transform sets is based on the intra prediction mode of the current block.

8. The method of claim 7, wherein the number of the secondary transform sets is based on a delta angle of the intra prediction mode.

9. The method of claim 7, wherein the number of the secondary transform sets is based on whether the intra prediction mode is a directional mode.

10. The method of claim 1, wherein a number of secondary transform sets in the plurality of secondary transform sets is based on a primary transform type for the current block.

11. The method of claim 10, wherein the number of secondary transform sets is based on whether the primary transform type includes a discrete cosine transform (DCT).

12. The method of claim 1, wherein a number of secondary transform sets in the plurality of secondary transform sets is based on an end-of-block (EOB) value for the current block.

13. The method of claim 12, wherein an index is signaled for the selected secondary transform set when the EOB value is greater than a threshold amount.

14. The method of claim 13, wherein the threshold amount is an integer in a range of 1 to 64.

15. The method of claim 12, wherein the number of secondary transform sets in the plurality of secondary transform sets is based on the EOB value being within an EOB group of a plurality of EOB groups.

16. The method of claim 1, wherein a number of secondary transform sets in the plurality of secondary transform sets is based on a block size of the current block.

17. The method of claim 16, wherein the number of secondary transform sets is based on whether a dimension of the current block is less than a threshold value.

18. The method of claim 1, further comprising entropy decoding a syntax element of the video bitstream to determine an index for the secondary transform set, wherein a context for the entropy decoding is based on at least one of: a block size of the current block, a transform type for the current block, and an EOB value for the current block.

19. A method of video encoding performed at a computing system having memory and one or more processors, the method comprising:
receiving video data comprising a plurality of blocks that includes a current block;
determining an intra prediction mode for the current block;
selecting a secondary transform set from a plurality of secondary transform sets based on the intra prediction mode of the current block; and
encoding the current block by applying a secondary transform from the selected secondary transform set.

20. A non-transitory computer-readable storage medium storing a video bitstream that is generated by a video encoding method, the video encoding method comprising:
receiving video data comprising a plurality of blocks that includes a current block;
determining an intra prediction mode for the current block;
selecting a secondary transform set from a plurality of secondary transform sets based on the intra prediction mode of the current block; and
encoding the current block by applying a secondary transform from the selected secondary transform set,
wherein the video bitstream comprises the encoded current block.
